(19) United States
(12) Patent Application Publication
(10) Pub. No.: US 2012/0098831 A1
(43) Pub. Date: Apr. 26, 2012

(54) 3D DISPLAY APPARATUS AND METHOD FOR PROCESSING 3D IMAGE

(75) Inventors: Sang-won KIM, Seoul (KR); Joo-won LEE, Suwon-si (KR)

(73) Assignee: SAMSUNG ELECTRONICS CO., LTD., Suwon-si (KR)

(21) Appl. No.: 13/189,879

(22) Filed: Jul. 25, 2011

(30) Foreign Application Priority Data
Oct. 20, 2010 (KR) 2010-0102474

(51) Int. Cl. G06T 15/00; G06T 15/50

(52) U.S. Cl. 345/426; 345/419

(57) ABSTRACT

A three-dimensional (3D) image processing apparatus and a method for processing a 3D image are provided. The 3D image processing apparatus includes a control unit which independently sets a left-eye image quality of a left-eye image and a right-eye image quality of a right-eye image; and a 3D implementation unit which processes the left-eye image and the right-eye image in accordance with the set left-eye image quality and the set right-eye image quality, wherein the left-eye image and the right-eye image are included in a 3D image.

### CROSS-REFERENCE TO RELATED PATENT APPLICATION

This application claims priority from Korean Patent Application No. 10-2010-0102474, filed on Oct. 20, 2010 in the Korean Intellectual Property Office, the disclosure of which is incorporated herein in its entirety by reference.

### BACKGROUND

1. Field

Apparatuses and methods consistent with exemplary embodiments relate to a three-dimensional (3D) display apparatus and a method for processing a 3D image, and more particularly to a 3D display apparatus and a method for processing a 3D image, which can display a 3D image that includes a left-eye image and a right-eye image.

2. Description of the Related Art

3D stereoscopic image technology has very diverse application fields, such as information communication, broadcasting, medical treatment, educational training, military affairs, gaming, animation, virtual reality, computer aided drafting (CAD), industrial technology, and the like, and may be a core basic technology of next-generation 3D stereoscopic multimedia information communication which is commonly used in these fields.

In general, a 3D sense occurs from a complex effect of the degree of change in thickness of a crystalline lens according to the position of an object to be observed, a difference in angle between both eyes and an object, a difference in position and shape of an object between left and right eyes, disparity occurring in accordance with the movement of an object, and other effects caused by various kinds of psychological and memory effects.

Among them, the binocular disparity that occurs due to a distance of about 6-7 cm between a person's left eye and right eye may be the most important factor. Due to the binocular disparity, the two eyes see the same object at different angles, and due to this difference in angle between the two eyes, different images are formed in the two eyes, respectively. These two images are transferred to the viewer's brain through the retinas, and the brain accurately harmonizes these two kinds of information, resulting in the viewer perceiving the original 3D stereoscopic image.

A 3D image display apparatus may be classified into a glasses type that uses special glasses and a non-glasses type that does not use the special glasses. The glasses type may be divided into a color filter type that separates and selects an image using a color filter, a polarizing filter type that separates an image into a left-eye image and a right-eye image using a shield effect caused by a combination of orthogonal polarizing elements, and a shutter glasses type that alternately blocks a left eye and a right eye in accordance with a sync signal for projecting a left-eye image signal and a right-eye image signal onto a screen to make the viewer feel the 3D effect.

A 3D image is composed of a left-eye image that is recognized by a left eye and a right-eye image that is recognized by a right eye. Also, the 3D display apparatus expresses a 3D effect of an image using the disparity between the left-eye image and the right-eye image.

In general, the 3D display apparatus displays the left-eye image and the right-eye image with the same picture quality. Accordingly, if a user's left eye and right eye have different eyesight, a difference may occur between images observed by both eyes, and this may cause the user feel eye fatigue and discomfort.

In the case of using a display apparatus, a viewer desires to view a normal 3D image. Accordingly, there is a need for schemes for displaying a 3D image in consideration of a user's eyes.

### SUMMARY

Exemplary embodiments address at least the above problems and/or disadvantages and provide at least the advantages described below. Aspects of exemplary embodiments provide a three-dimensional (3D) image processing apparatus and a method for processing a 3D image, which can process and display an input 3D image so that a left-eye image and a right-eye image included in the 3D image have different image qualities.

According to an aspect of an exemplary embodiment, there is provided a 3D image processing apparatus including: a control unit which independently sets a left-eye image quality of a left-eye image and a right-eye image quality of a right-eye image; and a 3D implementation unit which processes the left-eye image and the right-eye image in accordance with the set left-eye image quality and the set right-eye image quality.

The 3D implementation unit may process the left-eye image and the right-eye image by applying a left-eye image quality value to the left-eye image and applying a right-eye image quality value to the right-eye image.

The control unit may set the left-eye image quality value and the right-eye image quality value in accordance with a user's operation.

The control unit may display at least one of the left-eye image and the right-eye image to which at least one of a plurality of image quality values is applied, and to set an image quality value selected from among the plurality of image quality values in accordance with a user's selection operation as an image quality value of the displayed image.

The control unit may display the left-eye image to which the at least one of the plurality of image quality values is applied, and to set the image quality value selected from among the plurality of image quality values as the left-eye image quality value.

The control unit may display the right-eye image to which the at least one of the plurality of image quality values is applied, and to set the image quality value selected from among the plurality of image quality values as the right-eye image quality value.

The control unit may simultaneously display the left-eye image to which at least one first image quality value from among the plurality of image quality values is applied and the right-eye image to which at least one second image quality value from among the plurality of image quality values is applied, and to set the first image quality value selected by the user from among the at least one first image quality value as the left-eye image quality value and a second image quality value selected by the user from among the at least one second image quality value as the right-eye image quality value.

The image quality value may be at least one of a frequency characteristic value, a luminance characteristic value, and a color characteristic value.

The control unit may operate to display an eyesight input menu to receive an eyesight input that corresponds to the frequency characteristic value.

The control unit may receive a user's selection operation regarding whether a user's eye is affected with color blindness or cataracts, set the image quality value as a color characteristic value when the color blindness is selected, and set the image quality value as a luminance characteristic value when the cataracts is selected.

According to an aspect of another exemplary embodiment, there is provided a method for processing a 3D image, the method including: receiving the 3D image including a left-eye image and a right-eye image; independently setting a left-eye image quality of the left-eye image and a right-eye image quality of the right-eye image; and processing the left-eye image and the right-eye image in accordance with the set left-eye image quality and the set right-eye image quality.

The processing may include applying a left-eye image quality value to the left-eye image and applying a right-eye image quality value to the right-eye image.

The independently setting may include independently setting the left-eye image quality value and the right-eye image quality value in accordance with a user's operation, and the applying may include applying the set left-eye image quality value and the set right-eye image quality value.

The independently setting may include: displaying at least one of the left-eye image and the right-eye image to which at least one of a plurality of image quality values is applied; and setting an image quality value selected from among the plurality of image quality values in accordance with a user's selection operation as an image quality value of the displayed image.

The setting may include: displaying the left-eye image to which the at least one of the plurality of image quality values is applied; and setting the image quality value selected from among the plurality of image quality values as the left-eye image quality value.

The setting may include: displaying the right-eye image to which the at least one of the plurality of image quality values is applied; and setting the image quality value selected from among the plurality of image quality values as the right-eye image quality value.

The setting may include: simultaneously displaying the left-eye image to which at least one first image quality value from among the plurality of image quality values is applied and the right-eye image to which at least one second image quality value from among the plurality of image quality values is applied; and setting a first image quality value selected by the user from among the at least one first image quality value as the left-eye image quality value and the second image quality value selected by the user from among the at least one second image quality value as the right-eye image quality value.

The image quality value may be at least one of a frequency characteristic value, a luminance characteristic value, and a color characteristic value.

The method may further include controlling to display an eyesight input setting menu to receive an eyesight input that corresponds to the frequency characteristic value.

The method may further include: receiving a user's selection operation regarding whether a user's eye is affected with color blindness or cataracts; setting the image quality value as a color characteristic value when the color blindness is selected; and setting the image quality value as a luminance characteristic value when the cataracts is selected.

According to an aspect of another exemplary embodiment, there is provided a method for processing a 3D image, the method including: receiving the 3D image including a left-eye image and a right-eye image; processing the left-eye image and the right-eye image in accordance with a left-eye image quality value and a right-eye image quality value, wherein the left-eye image quality value is independent of the right-eye image quality value.

According to exemplary embodiments, a 3D image processing apparatus and a method for processing a 3D image are provided, which can process and display an input 3D image so that a left-eye image and a right-eye image included in the 3D image have different image qualities, thus corresponding to the user's eye states. Accordingly, the user can adjust the respective picture qualities of the left-eye image and the right-eye image to meet the user's eye states, such that a dizziness phenomenon or discomfort of the 3D image caused by the eyesight difference or the like can be reduced.

### BRIEF DESCRIPTION OF THE DRAWINGS

The above and/or other aspects, features and advantages will be more apparent from the following detailed description when taken in conjunction with the accompanying drawings, in which:

FIG. 1 is a view roughly illustrating external appearances of a three-dimensional (3D) television (TV) and 3D glasses according to an exemplary embodiment;

FIG. 2 is a block diagram illustrating a detailed configuration of a 3D TV according to an exemplary embodiment;

FIG. 3 is a block diagram illustrating a detailed configuration of 3D glasses according to an exemplary embodiment;

FIG. 4 is a flowchart illustrating in detail a method for processing a 3D image according to an exemplary embodiment;

FIGS. 5A and 5B are diagrams illustrating image quality setting menus for setting the sharpness of a left-eye image and a right-eye image according to a user's eyesight on a 3D TV, according to exemplary embodiments;

FIGS. 6A and 6C are diagrams illustrating image quality setting menus for setting image qualities according to whether a user suffers from eyeball diseases, according to an exemplary embodiment;

FIGS. 7A to 7G are diagrams illustrating a process of selecting image quality values of a left-eye image and a right-eye image using test images, according to an exemplary embodiment; and

FIG. 8 is a diagram illustrating a case where both a left-eye image and a right-eye image for testing are displayed on a screen, according to an exemplary embodiment.

### DETAILED DESCRIPTION OF EXEMPLARY EMBODIMENTS

Hereinafter, exemplary embodiments are described in detail with reference to the accompanying drawings. For reference, in explaining the exemplary embodiments, well-known operations or constructions will not be described in detail so as to avoid obscuring the description with unnecessary detail. Expressions such as “at least one of,” when preceding a list of elements, modify the entire list of elements and do not modify the individual elements of the list.

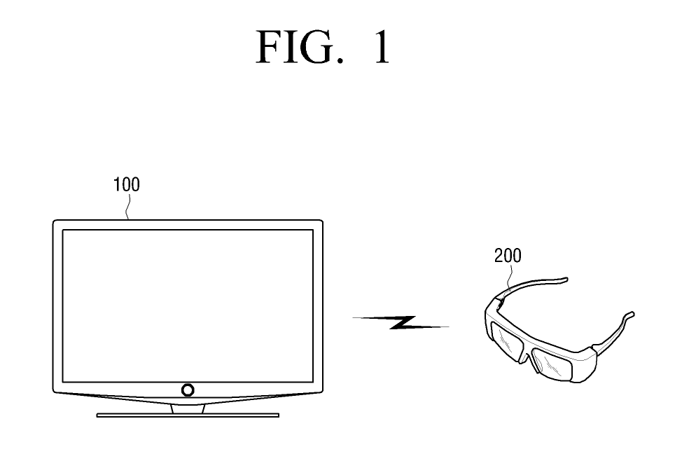

FIG. 1 is a view roughly illustrating external appearances of a three-dimensional (3D) television (TV) 100 and 3D glasses 200 according to an exemplary embodiment. As illustrated in FIG. 1, the 3D TV 100 and the 3D glasses 20 are communicable with each other, and operate in association with each other.

The 3D TV 100 generates and alternately displays a left-eye image and a right-eye image, and a user alternately sees the left-eye image and the right-eye image, which are displayed on the 3D TV 100, with the left eye and the right eye, respectively, using the 3D glasses 200.

Specifically, the 3D TV 100 separates the input 3D image into a left-eye image and a right-eye image, and alternately displays the left-eye image and the right-eye image at predetermined intervals.

In this case, the 3D TV 100 may process and display the left-eye image and the right-eye image with different image qualities. In particular, the 3D TV 100 may display the left-eye image and the right-eye image of the 3D image by reflecting a difference between a user's eyes in the case where the user's eyes are in different eye states, i.e., have different vision qualities.

Accordingly, the 3D TV 100 sets the image quality values for the left-eye image and the right-eye image in accordance with the user's eye states.

Also, the 3D TV 100 generates a synchronization signal for the generated left-eye image and right-eye image and transmits the generated synchronization signal to the 3D glasses 200. Here, the synchronization signal is a signal for synchronizing the 3D TV 100 and the 3D glasses 200 with each other. Specifically, the synchronization signal corresponds to a signal for matching the timing of alternately displaying the left-eye image and the right-eye image through the 3D TV 100 with the timing of opening and closing a left-eye glass and a right-eye glass of the 3D glasses 200.

The 3D glasses 200 receives the synchronization signal transmitted from the 3D TV 100, and alternately opens the left-eye glass and the right-eye glass in synchronization with the left-eye image and the right-eye image that is displayed on the 3D TV 100.

As described above, a user can view the 3D image using the 3D TV 100 and the 3D glasses 200 of FIG. 1. In this case, the 3D TV 100 may process and display the left-eye image and the right-eye image with different image qualities to meet the user's eye state.

Accordingly, the 3D TV 100 and the 3D glasses 200 can provide the 3D image that is suitable for the user's eye state. In relation to this, explanation will be made in more detail with reference to the accompanying drawings.

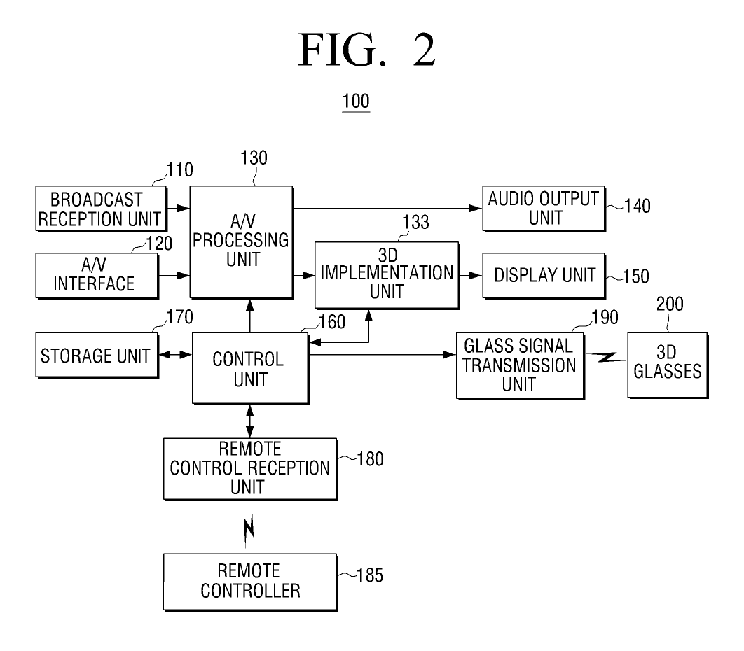

FIG. 2 is a block diagram illustrating a detailed configuration of a 3D TV 100 according to an exemplary embodiment. As illustrated in FIG. 2, the 3D TV 100 includes a broadcast reception unit 110, an A/V interface 120, an A/V processing unit 130, a 3D implementation unit 133, an audio output unit 140, a display unit 150, a control unit 160, a storage unit 170, a remote control reception unit 180, and a glasses signal transmission unit 190.

The broadcast reception unit 110 receives the broadcast from a broadcasting station or a satellite by wire or wirelessly and demodulates the received broadcast. Also, the broadcast reception unit 110 receives a 3D image signal for 3D image data.

The A/V interface 120 is connected to an external apparatus and receives an image from the external apparatus. In particular, the A/V interface 120 can receive 3D image data from the external apparatus. The A/V interface 120 may be an interface using, for example, an S-video component, composite, D-sub, DVI, HDMI, and the like.

Here, the 3D image data is data that includes 3D image information. The 3D image data includes left-eye image data and right-eye image data in one data frame region. Also, the 3D image data may be classified in accordance with a method of including the left-eye image data and the right-eye image data. For example, the 3D image data includes an interleave type, a side-by-side type, an top-and-bottom type, and the like.

The A/V processing unit 130 performs a signal processing, such as at least one of video decoding, video scaling, audio decoding, and the like, with respect to an input video signal and an audio signal.

Specifically, the A/V processing unit 130 performs a signal processing such as audio decoding with respect to the input audio signal, and outputs the processed audio signal to the audio output unit 140.

Also, the A/V processing unit 130 performs a signal processing, such as at least one of video decoding, video scaling, and the like, with respect to the input video signal. Also, if the 3D image data is input, the A/V processing unit 130 processes and outputs the input 3D image data to the 3D implementation unit 133.

The 3D implementation unit 133 separates the input 3D image data into a left-eye image and a right-eye image, which are interpolated with the size of a screen. That is, the 3D implementation unit 133 generates the left-eye image and the right-eye image to be displayed on the screen in order to implement a 3D stereoscopic image.

Specifically, the 3D implementation unit 133 separates the input 3D image data into the left-eye image data and the right-eye image data. Since one frame of the received 3D image data includes both the left-eye image data and the right-eye image data, each of the separated left-eye image data and right-eye image data has image data that corresponds to a half of the entire frame size. Accordingly, the 3D implementation unit 133 generates a left-eye image and a right-eye image that can be displayed on a screen having the size of one frame by enlarging or interpolating the separated left-eye image data and right-eye image data two times. However, the process of separating the 3D image data into the left-eye image and the right-eye image may differ according to the format of the 3D image data, and thus is not limited to that as described above.

Also, the 3D implementation unit 133 separates the input 3D image into the left-eye image and the right-eye image, and processes the left-eye image and the right-eye image so that the left-eye image and the right-eye image have different image qualities. In this case, the 3D implementation unit 133 processes the left-eye image and the right-eye image by applying a left-eye image quality value to the left-eye image and applying a right-eye image quality value to the right-eye image, respectively. Here, the left-eye image quality value and the right-eye image quality value may be set by a user's operation.

Also, the image quality value may be at least one of a frequency characteristic value, a luminance characteristic value, and a color characteristic value. The frequency characteristic value corresponds to an image quality value for adjusting the sharpness of the image, and is adjusted to compensate for an eyesight difference between a user's eyes. That is, the 3D implementation unit 133 applies the frequency characteristic value to the image for the eye having poor vision among the user's eyes so as to heighten the sharpness of the corresponding image, while it applies the frequency characteristic value to the image for the eye having good vision so as to lower the sharpness of the corresponding image. Accordingly, the 3D implementation unit 133 can process the sharpness of the left-eye image and the right-eye image to meet the eyesight of the left eye and the right eye, respectively.

The luminance characteristic value corresponds to the image quality value for adjusting the brightness of the image, and is adjusted to supplement the brightness of the images on the eyes in the case where a user has an eyeball disease, such as cataracts, and the user's eyes recognize different brightness for the same image. That is, the 3D implementation unit 133 applies the luminance characteristic value to the image for the eye having a poor brightness recognition capability due to a user's suffering from cataracts or the like so as to heighten the brightness of the corresponding image. Furthermore, the 3D implementation unit 133 applies the luminance characteristic value to the image on the normal eye having a good brightness recognition capability so as to lower the brightness of the corresponding image. Accordingly, the 3D implementation unit 133 can process the luminance of the left-eye image and the right-eye image to meet characteristics of the left eye and the right eye, respectively.

The color characteristic value corresponds to an image quality value for adjusting the color of the image, and is adjusted to supplement the color of the images on the eyes in the case where a user has an eyeball disease such as color blindness and the user's eyes recognize different colors for the same image. That is, the 3D implementation unit 133 applies the color characteristic values to the left-eye image and the right-eye image, respectively, so that the left eye and the right eye can recognize the same color for the image. Accordingly, the 3D implementation unit 133 can process the color of the left-eye image and the right-eye image to meet characteristics of the left eye and the right eye, respectively.

Also, the 3D implementation unit 133 outputs the left-eye image and the right-eye image which are processed with different image quality values.

The audio output unit 140 outputs the audio that is transmitted from the AN processing unit 130 to a speaker or the like.

The display unit 150 displays the image that is transmitted from the 3D implementation unit 133 on the screen. In particular, the display unit 150 alternately outputs the left-eye image and the right-eye image, to which different image qualities are applied, to the screen.

The storage unit 170 stores the image data received through the broadcast reception unit 110 or the interface 120. Also, the storage unit 170 may store a plurality of image quality values in the form of a table. Here, the image quality value includes at least one of the frequency characteristic value, the luminance characteristic value, and the color characteristic value. The frequency characteristic value may be stored in correspondence with the eyesight. The storage unit 170 may be implemented by a hard disk, a nonvolatile memory, and the like.

The remote control reception unit 180 receives a user's operation from the remote controller 185 and transmits the user's operation to the control unit 160. It is understood that other user input devices or methods may be used, such as a touch screen.

The glasses signal transmission unit 190 transmits a synchronization signal that is a clock signal for alternately opening the left-eye glass and the right-eye glass of the 3D glasses 200 using, for example, an infrared (IR) signal.

The control unit 160 receives a user command based on the user's operation of the remote controller 185, and controls an operation of the 3D TV 100 according to the received user command.

Specifically, the control unit 160 sets a left-eye image quality value and a right-eye image quality value according to the user's operation. That is, the user may separately input the left-eye image quality value and the right-eye image quality value using a user interface such as the remote controller 185. Accordingly, the control unit 160 receives the left-eye image quality value and the right-eye image quality value which are input by the user, and controls the 3D implementation unit 133 so that the input left-eye image quality value is applied to the left-eye image and the input right-eye image quality value is applied to the right-eye image. In this case, the control unit 160 may set the respective image quality values so that the left-eye image and the right-eye image have different image qualities.

The control unit 160 may display a Graphical User Interface (GUI) for a user to set the image quality values on the screen. Specifically, the control unit 160 may display a GUI for setting the sharpness (that is, frequency characteristic value) that corresponds to the eyesight. Here, the control unit operates to display the eyesight that corresponds to the frequency characteristic value.

Also, the control unit 160 may display a GUI for setting at least one of the luminance characteristic value and the color characteristic value according to whether a eye of the user is affected by color blindness or cataracts. The control unit 160 receives a user's selection operation on whether the user's eye is affected by color blindness or cataracts, and sets the image quality value to the color characteristic value in the case where the color blindness is selected, while it sets the image quality value to the luminance characteristic value in the case where the cataracts is selected.

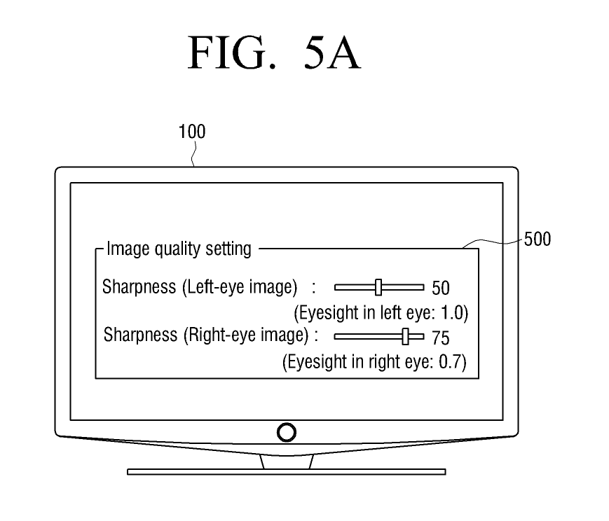

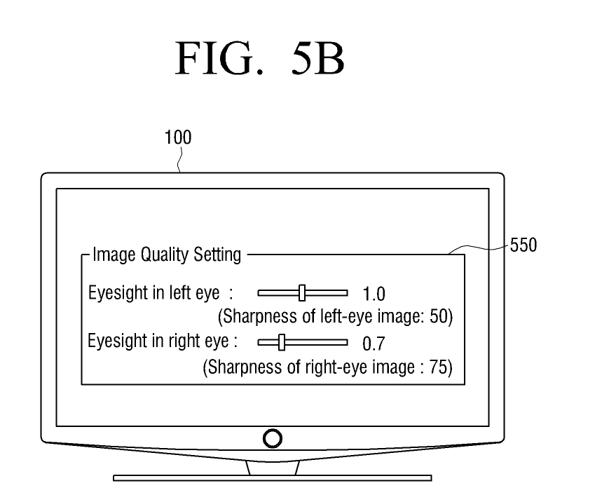

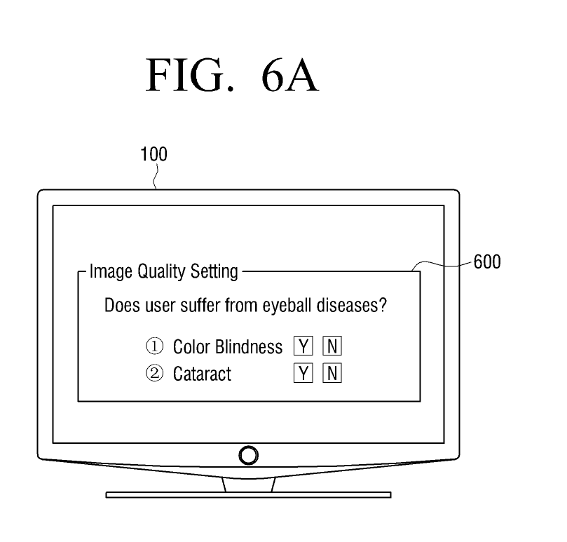

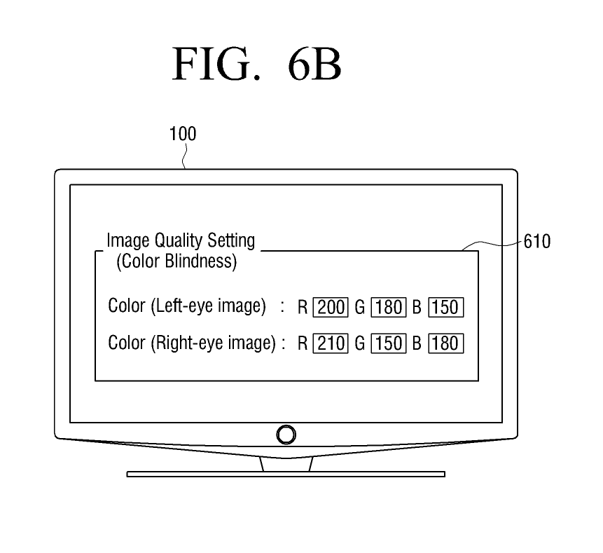

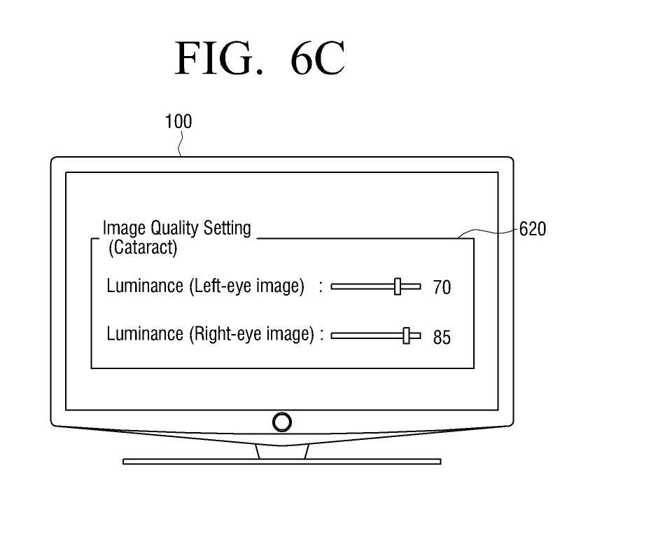

The details of the GUI for the user to set the image qualities of the left-eye image and the right-eye image will be described below with reference to the FIGS. 5A to 5B and 6A to 6C.

Furthermore, the control unit 160 may display a test image, and a user can set a desired image quality value after confirming in advance the image to which a certain image quality value has been applied. Specifically, the control unit 160 operates to display at least one of the left-eye image and the right-eye image, to which one of the plurality of image quality values has been applied, as a test image, and to set the image quality value selected from the plurality of image quality values as the left-eye image quality value or the right-eye image quality value in accordance with the user's selection operation.

In this case, the control unit 160 may implement a process of displaying the test image in the form of displaying one of the left-eye image and right-eye image.

Specifically, in the case of setting the left-eye image quality value, the control unit 160 operates to display the left-eye image to which one image quality value among the plurality of image quality values is applied. In this case, the control unit 160 can change the currently applied image quality value automatically or according to the user's operation, and display the left-eye image by applying the changed image quality value. For example, the control unit 160 may change the image quality value to the image quality value that is selected or input by the user. Also, the control unit 160 may automatically change the image quality value for a predetermined amount of value at predetermined intervals.

Accordingly, the user can confirm via the left-eye images to which diverse image quality values are applied. The control unit 160 sets the image quality value that is selected by the user among the plurality of image quality values as the left-eye image quality value.

Also, in the case of setting the right-eye image quality value, the control unit 160 operates to display the right-eye image to which one image quality value among the plurality of image quality values is applied. In this case, the control unit 160 can change the currently applied image quality value automatically or according to the user's operation, and display the right-eye image by applying the changed image quality value. Accordingly, the user can confirm via the right-eye images to which diverse image quality values are applied. The control unit 160 sets the image quality value that is selected by the user among the plurality of image quality values as the right-eye image quality value.

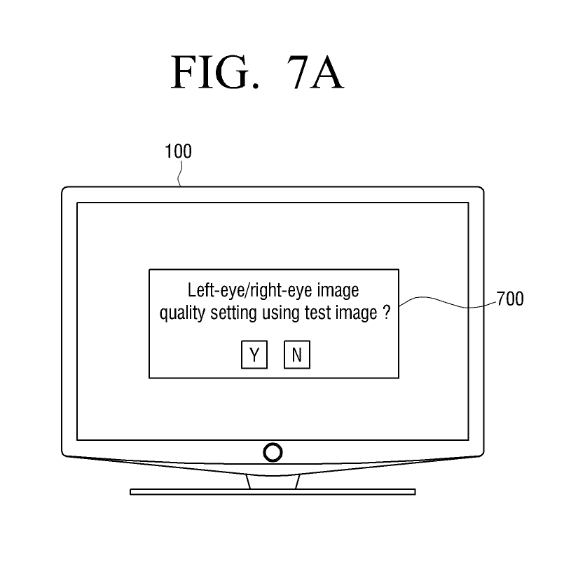

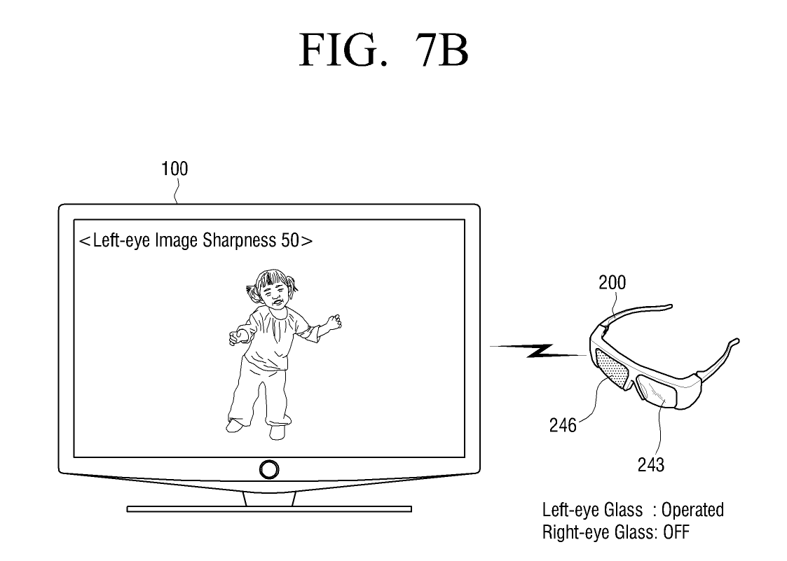

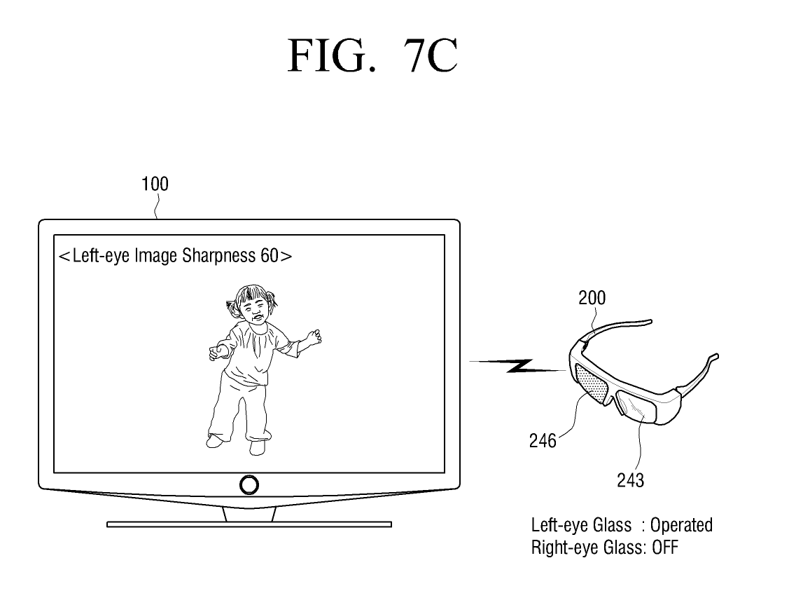

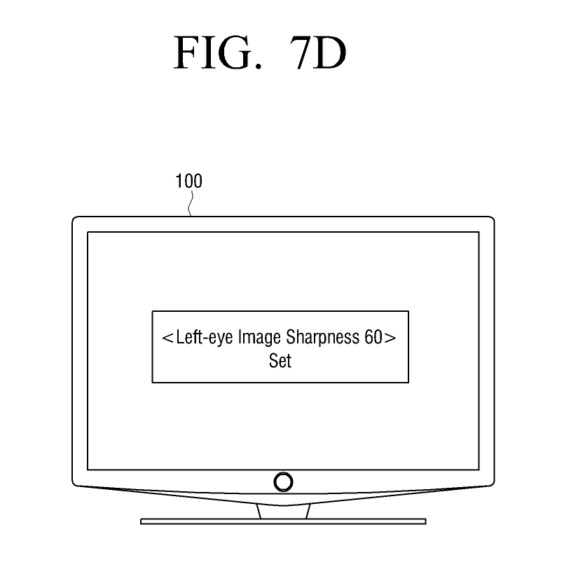

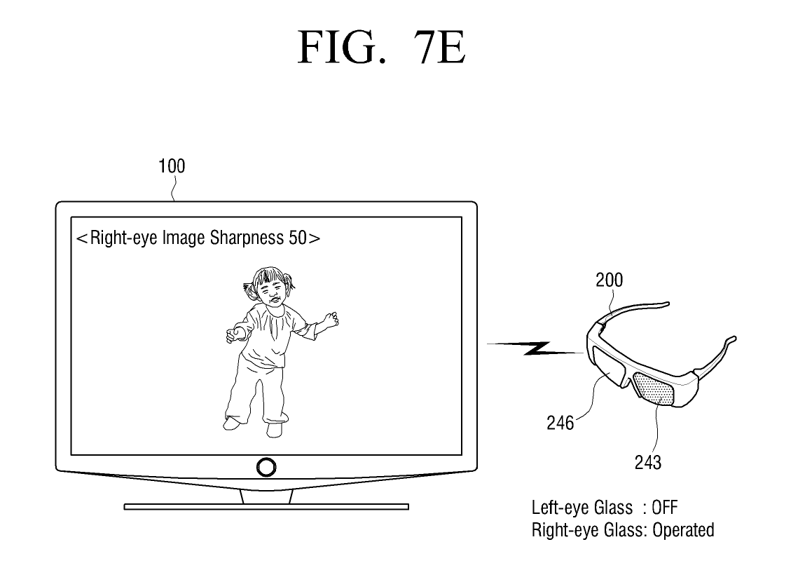

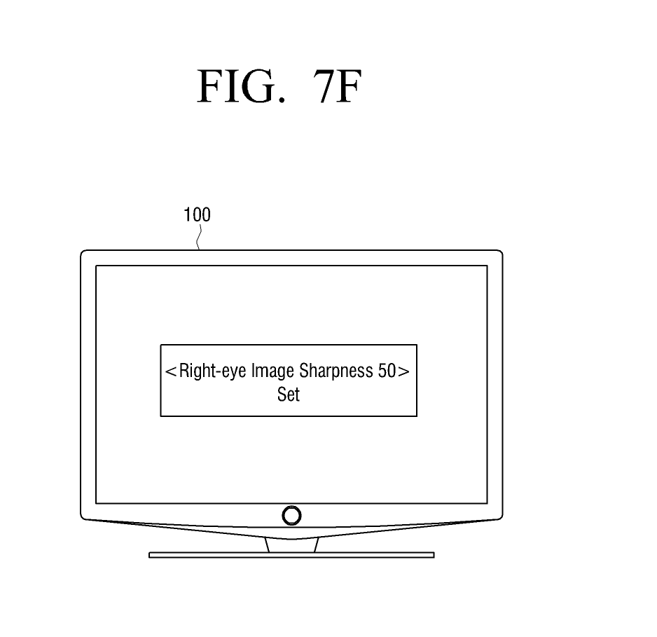

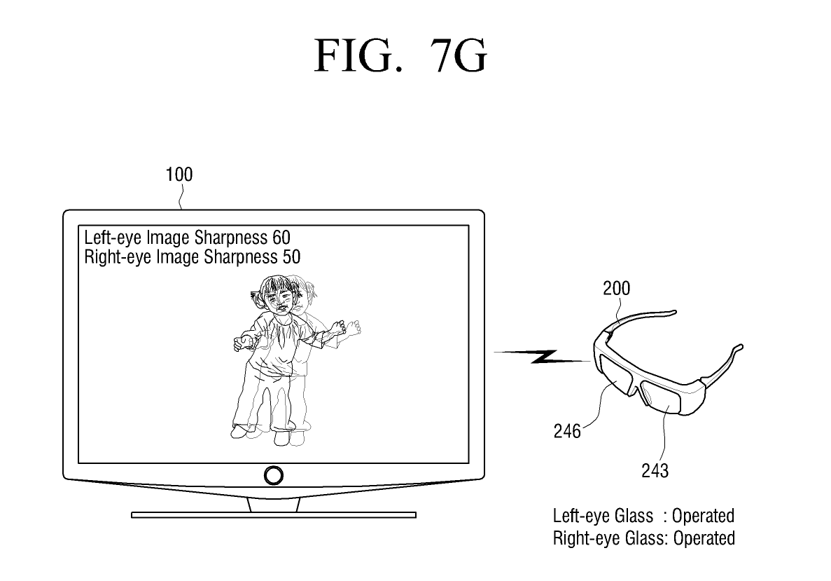

As described above, the control unit 160 may provide a test image for separately displaying the left-eye image and the right-eye image. For this, a detailed explanation will be provided below with reference to FIGS. 7A to 7G.

On the other hand, the control unit 160 may provide a test image for displaying both the left-eye image and the right-eye image in one screen. Specifically, the control unit 160 may operate to display both the left-eye image to which a first image quality value among the plurality of image quality values is applied and the right-eye image to which a second image quality value among the plurality of image quality values is applied. Also, the control unit 160 may change the applied first image quality value and second image quality value automatically or in accordance with the user's operation. Then, the control unit 160 displays the left-eye image and the right-eye image by applying the changed image quality value. Accordingly, the user can confirm via the left-eye images and the right-eye images to which diverse image quality values are applied. If the first image quality value and the second image quality value are selected by the user, the control unit 160 sets the first image quality value selected by the user among the plurality of image quality values as the left-eye image quality value and the second image quality value selected by the user as the right-eye image quality value.

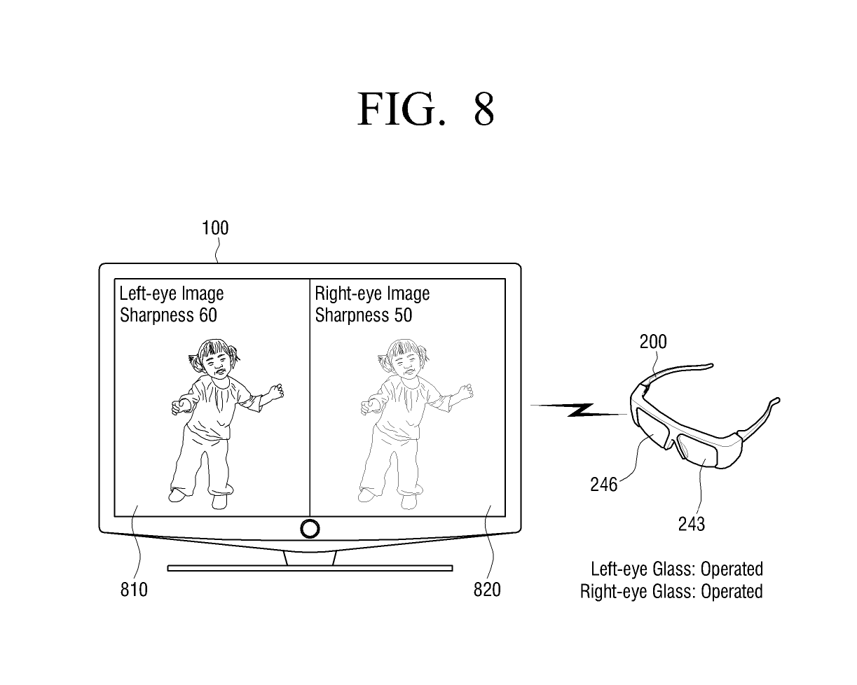

As described above, the control unit 160 can provide a test image for displaying both the left-eye image and the right-eye image. In this case, since the user can directly compare the image quality of the left-eye image and the image quality of the right-eye image in one screen, the user can adjust the image qualities of the left-eye image and the right-eye image so that the image qualities of the left-eye image and the right-eye image appear the same. For this, a detailed explanation will be provided below with reference to FIG. 8.

The 3D TV 100 having the above-described configuration processes and displays the left-eye image and the right-eye image with different image quality values in accordance with the user's eye state. Accordingly, the user can solve an unbalance of perceived image qualities of the left-eye image and the right-eye image due to the eyesight difference or the like.

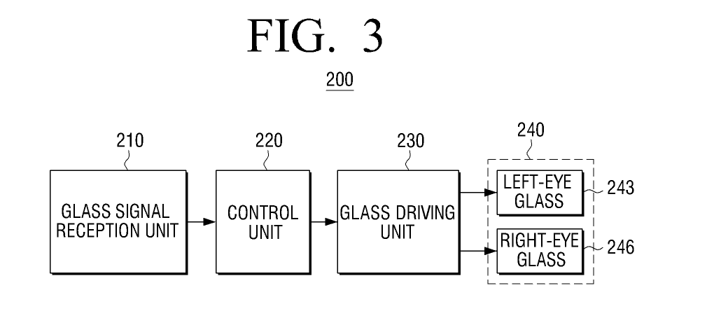

Hereinafter, with reference to FIG. 3, a detailed configuration of the 3D glasses 200 will be described. FIG. 3 is a block diagram illustrating a detailed configuration of 3D glasses 200 according to an exemplary embodiment.

As illustrated in FIG. 3, the 3D glasses 200 include a glasses signal reception unit 210, a control unit 220, a glasses driving unit 230, and a glasses unit 240.

The glasses signal reception unit 210 receives a synchronization signal of a 3D image using an infrared signal from the 3D TV 100. The 3D TV 100 radiates the synchronization signal using an infrared signal having directivity through the glasses signal transmission unit 190, and the glasses signal reception unit 210 of the 3D glasses 200 receives the synchronization signal by receiving the radiated infrared rays.

For example, the glasses synchronization signal that is transferred from the 3D TV 100 to the glasses signal reception unit 210 may be a signal that alternately repeats a high level in a first period and a low level in a second period at predetermined intervals. In this case, the 3D glasses 200 may be driven to open the left-eye glass 243 in the first period in which the synchronous signal is at high level, and to open the right-eye glass 246 in the second period in which the synchronous signal is at low level (or vice-versa).

It is understood that the synchronization signal need not be an infrared signal in another exemplary embodiment, and may be any communication signal (e.g., a ZigBee signal, a Bluetooth signal, etc.).

The control unit 220 controls the operation of the 3D glasses 200. Specifically, the control unit 220 operates to receive the synchronization signal from the 3D TV 100. Also, the control unit 220 transfers the received synchronization signal to the glasses driving unit 230, and controls the operation of the glasses driving unit 230 accordingly. In particular, the control unit 220 controls the glasses driving unit 230 to generate a driving signal for driving the glasses unit 240 based on the synchronization signal.

The glasses driving unit 230 generates the driving signal based on the synchronization signal received from the control unit 220. In particular, since the glasses unit 240, to be described below, includes the left-eye glass 243 and the right-eye glass 246, the glasses driving unit 230 generates a left-eye driving signal for driving the left-eye glass 243 and a right-eye driving signal for driving the right-eye glass 246, and transfers the generated left-eye driving signal to the left-eye glass 243 and the right-eye driving signal to the right-eye glass 246.

The glasses unit 240, as described above, includes the left-eye glass 243 and the right-eye glass, and alternately opens and closes the respective glasses according to the driving signal received form the glasses driving unit 230.

Using the 3D glasses 200 having the above-described configuration, the user can alternately see the left-eye image and the right-eye image displayed on the 3D TV 100 with the left eye and the right eye.

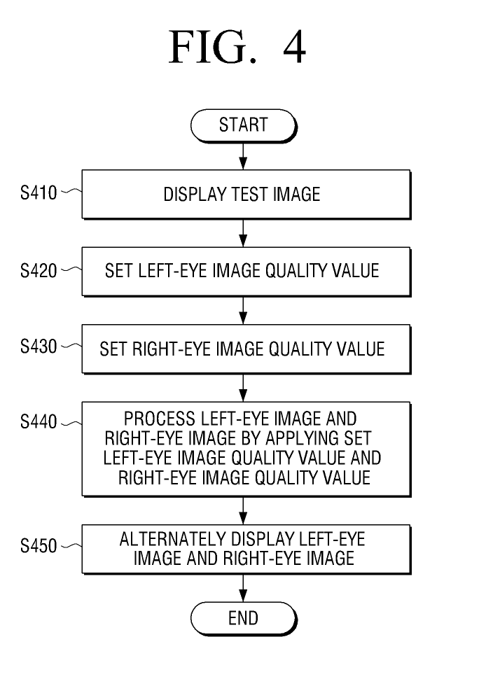

Hereinafter, with reference to FIG. 4, a method for processing a 3D image will be described. FIG. 4 is a flowchart illustrating in detail a method for processing a 3D image according to an exemplary embodiment.

If a user's left and right image quality setting command is input, the 3D TV 100 displays a test image (operation S410). Here, the test image is an image that is displayed so that a user confirms in advance the image to which an image quality value has been applied before the image quality values of the left-eye image and the right-eye image are set. That is, the user can select the image quality value of the most appropriate image quality after viewing the test images to which diverse image quality values are applied.

Thereafter, the 3D TV 100 sets the left-eye image quality value (operation S420). Specifically, in the case of setting the left-eye image quality value, the 3D TV 100 displays the left-eye image to which one image quality value among a plurality of image quality values is applied. In this case, the 3D TV 100 can change the currently applied image quality value automatically or according to the user's operation, and displays the left-eye image by applying the changed image quality value. Accordingly, the user can confirm via the left-eye images to which diverse image quality values are applied. Also, the 3D TV 100 sets the image quality value that is selected by the user among the plurality of image quality values as the left-eye image quality value.

Furthermore, the 3D TV 100 sets the right-eye image quality value (operation S430). Specifically, in the case of setting the right-eye image quality value, the 3D TV 100 displays the right-eye image to which one image quality value among a plurality of image quality values is applied. In this case, the 3D TV 100 can change the currently applied image quality value automatically or according to the user's operation, and displays the right-eye image by applying the changed image quality value. Accordingly, the user can confirm via the right-eye images to which diverse image quality values are applied. Then, the 3D TV 100 sets the image quality value that is selected by the user among the plurality of image quality values as the right-eye image quality value.

The 3D TV 100 processes the left-eye image and the right-eye image by applying the set left-eye image quality value and the set right-eye image quality value (operation S440). Then, the 3D TV 100 alternately displays the left-eye image and the right-eye image (operation S450).

Through the above-described process, the 3D TV 100 displays the left-eye image and the right-eye image having different image qualities in consideration of the states of a user's eyes. Accordingly, the user can view the 3D image having the image qualities that respectively correspond to the states of the user's eyes.

Hereinafter, with reference to FIGS. 5A to 5B and 6A to 6C, a process of providing a GUI for an image quality setting menu will be described in detail. FIGS. 5A and 5B are diagrams illustrating image quality setting menus for setting the sharpness of a left-eye image and a right-eye image according to a user's eyesight on a 3D TV according to exemplary embodiments.

FIG. 5A illustrates a state where an image quality setting menu 500 for the sharpness is displayed on the screen of the 3D TV 100. As illustrated in FIG. 5A, the sharpness (that is, frequency characteristic value) of the left-eye image and the sharpness of the right-eye image are separately set in the image quality setting menu 500 of the 3D TV 100.

Also, the eyesight of the left eye, which corresponds to the sharpness of the left-eye image, and the eyesight of the right eye, which corresponds to the sharpness of the right-eye image, are displayed together in the image quality setting menu 500. Accordingly, the user can easily select the sharpness that meets the user's eyesight.

FIG. 5B illustrates a state where an image quality setting menu 550 for the eyesight is displayed on the screen of the 3D TV 100. As illustrated in FIG. 5B, the eyesight of the left eye and the eyesight of the right eye are separately set in the image quality setting menu 550 of the 3D TV 100.

Also, the sharpness of the left-eye image, which corresponds to the eyesight of the left eye, and the sharpness of the right-eye image, which corresponds to the eyesight of the right eye, are displayed together in the image quality setting menu. Accordingly, the user can easily select the sharpness that meets the user's eyesight.

As described above, according to the 3D TV 100, the sharpness of the left-eye image and the sharpness of the right-eye image can be separately set through the image quality setting menu. Accordingly, the user can set the sharpness of the left-eye image and the sharpness of the right-eye image to meet the eyesight in the left eye and the eyesight in the right eye, respectively.

Hereinafter, with reference to FIGS. 6A to 6C, an image quality setting process according to eyeball diseases will be described. FIGS. 6A to 6C are diagrams illustrating image quality setting menus for setting image qualities according to whether a user suffers from eyeball diseases according to an exemplary embodiment.

As illustrated in FIG. 6A, the 3D TV 100 displays, on the screen, a menu 600 for selecting whether a user suffers from an eyeball disease. In the menu 600 as illustrated in FIG. 6A, color blindness and cataracts are displayed as kinds of eyeball diseases. However, the applicable eyeball diseases are not limited thereto.

If color blindness is selected by the user, the 3D TV 100 displays an image quality setting menu 610 related to color blindness on the screen, as illustrated in FIG. 6B. As illustrated in FIG. 6B, the image quality setting menu 610 related to color blindness is displayed so that colors (that is, color characteristic values) of the left-eye image and the right-eye image can be separately set.

Also, if cataracts is selected by the user, the 3D TV 100 displays an image quality setting menu 620 related to cataracts on the screen, as illustrated in FIG. 6C. As illustrated in FIG. 6C, the image quality setting menu 620 related to cataracts is displayed so that luminance (that is, luminance characteristic values) of the left-eye image and the right-eye image can be separately set.

As described above, the user can select the user's eyeball disease using the GUI menu displayed on the 3D TV 100, and can select the image quality values of the left-eye image and the right-eye image separately in accordance with the kind of the eyeball disease.

Thus, a case where a user directly selects the image quality values has been described with reference to FIGS. 5A to 5B and 6A to 6C. However, the method of inputting the image quality values may correspond to the case where the user inputs a command using a test image in addition to the case where the user directly inputs numeral values.

Hereinafter, with reference to FIGS. 7A to 7G and 8, a process of selecting a left-eye image quality value and a right-eye image quality value by the user using a test image will be described. FIGS. 7A to 7G are diagrams illustrating a process of selecting image quality values of a left-eye image and a right-eye image using test images according to an exemplary embodiment. FIGS. 7A to 7G illustrate cases where test images, which separately display the left-eye image and the right-eye image, are applied.

FIG. 7A illustrates the screen of the 3D TV 100 on which a message 700 for image quality setting using a test image is displayed. If “Y” is selected in the message illustrated in FIG. 7A, the 3D TV 100 displays a left-eye image having a sharpness of 50 as a test image, as illustrated in FIG. 7B. In this case, the 3D TV 100 displays only the left-eye image from among the left-eye image and the right-eye image, and in the 3D glasses 200, the left-eye glass 243 is operated while the right-eye glass is in an off state (that is, in a closed state).

Accordingly, the user can view the 3D TV 100 with only the left eye, and in this state, the user can confirm whether the left-eye image has a sharpness that is appropriate to the left eye.

Also, according to the user's operation, the 3D TV 100 may change the image quality value applied to the test image. For example, if an operation for changing the sharpness to 60 is input, the 3D TV 100 displays a left-eye image to which the sharpness of 60 is applied as the test image, as illustrated in FIG. 7C.

As described above, the user can confirm via the left-eye images to which diverse image quality values are applied by changing the applied image quality values using the test images for the left-eye images. If the user selects a test image that is most appropriate to the left eye among the diverse image quality values, the 3D TV 100 sets the image quality value that corresponds to the selected test image as the left-eye image quality value.

Accordingly, as illustrated in FIG. 7C, if the user determines the left-eye image quality value in a state where the left-eye image having the sharpness of 60 is displayed, the 3D TV 100 displays a message indicating that the left-eye image quality value has been set to “sharpness 60,” as illustrated in FIG. 7D.

If the left-eye image quality value is determined as described above, the 3D TV 100, as illustrated in FIG. 7E, displays the right-eye image having the sharpness of 50 as a test image to set the right-eye image quality value. In this case, the 3D TV 100 displays only the right-eye image from among the left-eye image and the right-eye image, and the right-eye glass 246 is operated while the left-eye glass 243 is in an off state (that is, in a closed state) in the 3D glasses 200.

Accordingly, the user can view the 3D TV 100 with only the right eye, and in this state, the user can confirm whether the right-eye image has a sharpness that is appropriate to the right eye.

As described above, the user can confirm via the right-eye images to which diverse image quality values are applied by changing the applied image quality values using the test images for the right-eye images. If the user selects a test image that is most appropriate to the right eye among the diverse image quality values, the 3D TV 100 sets the image quality value that corresponds to the selected test image as the right-eye image quality value.

Accordingly, as illustrated in FIG. 7E, if the user determines the right-eye image quality value in a state where the right-eye image having the sharpness of 50 is displayed, the 3D TV 100 displays a message indicating that the right-eye image quality value has been set to “sharpness 50,” as illustrated in FIG. 7F.

If the setting of the left-eye image quality value and the right-eye image quality value is completed as described above, the 3D TV 100 alternately displays the left-eye image and the right-eye image which have been processed with the set left-eye image quality value and the set right-eye image quality value. That is, as illustrated in FIG. 7G, the sharpness of the left-eye image is set to 60 and the sharpness of the right-eye image is set to 50. Also, as illustrated in FIG. 7G, in the 3D glasses 200, the left-eye glass 243 and the right-eye glass 246 are operated.

Through the above-described process, the 3D TV 100 displays the left-eye image and the right-eye image as test images. Accordingly, the user can set the left-eye image quality value and the right-eye image quality value by confirming the test images for the left-eye image and the right-eye image.

In FIGS. 7A to 7G, it is exemplified that the left-eye image and the right-eye image are separately displayed as the test images. However, it is also possible to implement a test image in which the left-eye image and the right-eye image are displayed together.

A test image in which the left-eye image and the right-eye image are displayed together will be described with reference to FIG. 8. FIG. 8 is a diagram illustrating a case where both a left-eye image and a right-eye image for test are displayed on a screen according to an exemplary embodiment.

FIG. 8 illustrates a case where the 3D TV 100 displays a left-eye image 810 and a right-eye image 820 on one screen as test images. As illustrated in FIG. 8, the sharpness of the left-eye image 810 is 60 and the sharpness of the right-eye image 820 is 50. Also, the image quality value may be changed by a user and the changed image quality value may be applied.

As described above, the 3D TV 100 may display the left-eye image and the right-eye image on separate areas on a screen as test images.

The user can compare the left-eye image and the right-eye image to which different image quality values are applied on one screen, and through this, can set the left-eye image quality value and the right-eye image quality value so that the left-eye image and the right-eye image appear almost the same.

In the above-described exemplary embodiments, the display apparatus is described as a 3D TV 100. However, this is merely exemplary, and other exemplary embodiments may be applied to any device that can display a 3D image. For example, the display apparatus may be a 3D monitor, a 3D notebook computer, and the like, in addition to the 3D TV. Moreover, it is understood that exemplary embodiments are not limited to a display apparatus, and may be applied to any image processing apparatus that processes and outputs an image signal (e.g., an image processing apparatus that does not include a display unit, such as a set-top box).

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, one or more units of the display apparatus 100 or image processing apparatus can include a processor or microprocessor executing a computer program stored in a computer-readable medium.

While exemplary embodiments have been shown and described above with reference to the drawings, it will be understood by those skilled in the art that various changes in form and detail may be made therein without departing from the spirit and scope of the inventive concept, as defined by the appended claims.

1. A three-dimensional (3D) image processing apparatus comprising:
a control unit which independently sets a left-eye image quality of a left-eye image and a right-eye image quality of a right-eye image; and
a 3D implementation unit which processes the left-eye image and the right-eye image in accordance with the set left-eye image quality and the set right-eye image quality,
wherein the left-eye image and the right-eye image are included in a 3D image.

2. The 3D image processing apparatus as claimed in claim 1, wherein the 3D implementation unit processes the left-eye image and the right-eye image by applying a left-eye image quality value to the left-eye image and applying a right-eye image quality value to the right-eye image.

3. The 3D image processing apparatus as claimed in claim 2, wherein the control unit sets at least one of the left-eye image quality value in accordance with a left-eye user input and the right-eye image quality value in accordance with a right-eye user input.

4. The 3D image processing apparatus as claimed in claim 3, wherein the control unit displays one of the left-eye image and the right-eye image to which at least one of a plurality of image quality values is applied, and sets an image quality value selected from among the at least one of the plurality of image quality values in accordance with one of the left-eye and the right-eye user inputs as an image quality value of the displayed one of the left-eye image and the right-eye image.

5. The 3D image processing apparatus as claimed in claim 3, wherein the control unit displays the left-eye image to which at least one of a plurality of image quality values is applied, and sets an image quality value selected by a user from among the at least one of the plurality of image quality values as the left-eye image quality value.

6. The 3D image processing apparatus as claimed in claim 3, wherein the control unit displays the right-eye image to which at least one of a plurality of image quality values is applied, and sets an image quality value selected by a user from among the at least one of the plurality of image quality values as the right-eye image quality value.

7. The 3D image processing apparatus as claimed in claim 3, wherein the control unit operates simultaneously displays the left-eye image to which at least one first image quality value from among a plurality of image quality values is applied and the right-eye image to which at least one second image quality value from among the plurality of image quality values is applied, and sets a first image quality value selected by a user from among the at least one first image quality value as the left-eye image quality value and a second image quality value selected by the user from among the at least one second quality value as the right-eye image quality value.

8. The 3D image processing apparatus as claimed in claim 1, wherein the left eye image quality value and the right eye image quality value are at least one of a frequency characteristic value, a luminance characteristic value, and a color characteristic value.

9. The 3D image processing apparatus as claimed in claim 8, wherein the control unit operates to display an eyesight input setting menu to receive an eyesight input that corresponds to the frequency characteristic value.

10. The 3D image processing apparatus as claimed in claim 1, further comprising a display unit which displays the processed left-eye image and the processed right-eye image.

11. A method for processing a 3D image, the method comprising:
receiving the 3D image including a left-eye image and a right-eye image;
independently setting a left-eye image quality of the left-eye image and a right-eye image quality of the right-eye image; and
processing the left-eye image and the right-eye image in accordance with the set left-eye image quality and the set right-eye image quality.

12. The method for processing the 3D image as claimed in claim 11, wherein the processing comprises applying a left-eye image quality value to the left-eye image and applying a right-eye image quality value to the right-eye image.

13. The method for processing the 3D image as claimed in claim 12, wherein:
the independently setting comprises setting at least one of the left-eye image quality value in accordance with a left-eye user input and the right-eye image quality value in accordance with a right-eye user input; and
the applying comprises applying the set at least one of the left-eye image quality value and the right-eye image quality value.

14. The method for processing the 3D image as claimed in claim 13, wherein the setting the at least one of the left-eye image quality value and the right-eye image quality value comprises:
displaying one of the left-eye image and the right-eye image to which at least one of a plurality of image quality values is applied; and
setting an image quality value selected from among the at least one of the plurality of image quality values in accordance with one of the left-eye and the right-eye user inputs as an image quality value of the displayed one of the left-eye image and the right-eye image.

15. The method for processing the 3D image as claimed in claim 13, wherein the setting the at least one of the left-eye image quality value and the right-eye image quality value comprises:
displaying the left-eye image to which at least one of a plurality of image quality values is applied; and
setting an image quality value selected by a user from among the at least one of the plurality of image quality values as the left-eye image quality value.

16. The method for processing the 3D image as claimed in claim 13, wherein the setting the at least one of the left-eye image quality value and the right-eye image quality value comprises:
displaying the right-eye image to which at least one of a plurality of image quality values is applied; and
setting an image quality value selected by a user from among the at least one of the plurality of image quality values as the right-eye image quality value.

17. The method for processing the 3D image as claimed in claim 13, wherein the setting comprises:
simultaneously displaying the left-eye image to which at least one first image quality value from among a plurality of image quality values is applied and the right-eye image to which at least one second image quality value from among the plurality of image quality values is applied; and
setting a first image quality value selected by a user from among the at least one first image quality value as the left-eye image quality value and a second image quality value selected by the user from among the at least one second image quality value as the right-eye image quality value.

18. The method for processing the 3D image as claimed in claim 11, wherein the left-eye image quality value and the right-eye image quality value are at least one of a frequency characteristic value, a luminance characteristic value, and a color characteristic value.

19. The method for processing the 3D image as claimed in claim 18, further comprising controlling to display an eyesight input setting menu to receive an eyesight input that corresponds to the frequency characteristic value.

20. A method for processing a 3D image, the method comprising:
receiving the 3D image including a left-eye image corresponding to a frame of the 3D image and a right-eye image corresponding to the frame of the 3D image;
processing the left-eye image and the right-eye image in accordance with a left-eye image quality value and a right-eye image quality value,
wherein the left-eye image quality value is independent of the right-eye image quality value.
